(19) United States
(12) Patent Application Publication
(10) Pub. No.: US 2011/0215545 A1
(43) Pub. Date: Sep. 8, 2011

(54) FRONT AXLE BRACKET FOR A MOTOR VEHICLE AND METHOD FOR THE PRODUCTION THEREOF

(75) Inventors: Thomas Buschjohann, Nordstemmen (DE); Edvin List Clausen, Abenra (DK)

(73) Assignee: KSM Castings GmbH, Hildesheim (DE)

(21) Appl. No.: 12/998,535

(22) PCT Filed: Oct. 12, 2009
(86) PCT No.: PCT/DE2009/001400

§ 371 Date: Apr. 29, 2011

(30) Foreign Application Priority Data
Oct. 30, 2008 (DE) 102008054039.0

(51) Int. Cl. B62D 21/11; B21D 43/28

(52) U.S. Cl. 280/124.109; 72/324

(57) ABSTRACT

The invention relates to a front axle bracket for a motor vehicle.

The invention relates to a front axle bracket for a motor vehicle and a method for the production thereof.

Such front axle brackets are also designated inter alia as supporting frames or suspension subframes, or also generally as subframes or frames. They serve to receive wheel guide suspension links and further assemblies and auxiliary assemblies and are fastened as pre-mounted units or modules on the vehicle structure, e.g. on the body and/or on longitudinal beams of the vehicle.

The front axle bracket generally has a mount respectively on its two sides, with each mount being provided respectively for the bearings of one of the two wheel guide suspension links, such as e.g. a transverse link, triangular link or semi-trailing link. Furthermore, for example mounts are constructed for the fastening of a steering gear, the stabilizer and other assemblies. Such a front axle bracket is shown for example in DE 199 20 051 A1.

However, such front axle brackets are very intricate to produce, because for this to some extent very complex longitudinal and transverse beams are produced separately, e.g. by internal high-pressure deformation methods.

DE 10 2006 042 377 A1 shows a front axle bracket which has mounts or recesses for the fastening of the steering gear, the stabilizer and the bearing of a pendulum support and is produced from light metal in one piece with these mounts and recesses. The production as a single-piece pressure die casting basically makes a rapid production possible with few process steps, e.g. only a casting process with finishing. However, the result in such systems are a high overall weight and high material costs.

The invention is based on the problem of creating a front axle bracket for a motor vehicle and a method for the production thereof, which make possible a favourably-priced production with little complexity, with a stable construction and the connection of various components.

This problem is solved by a front axle bracket according to claim 1, and a method according to claim 13. The subclaims describe preferred further developments.

According to the invention, a central transverse beam is therefore produced separately from the outer consoles and these components are subsequently connected with each other, preferably welded, also screwed if applicable. The two lateral consoles can be constructed in particular as cast parts at a favourable cost with a stable structure and a low weight. The separate production of the lateral consoles independently of the central transverse beam makes greater freedoms possible here in the design, both with regard to the construction of mounts and also with regard to the rigidity by ribs, etc. The consoles preferably have mounts for fastening on the vehicle and bearing mounts for wheel guide suspension links.

According to the invention, the central transverse beam is constructed as an extruded section which has a double-walled region. The double-walled region makes a high degree of rigidity possible here, wherein preferably at least one cavity extends in transverse direction through the transverse beam. Expediently, the double-walled region is constructed in an angular manner with a front horizontal web and an adjoining vertical web. Particularly preferably, a wall is formed here between the front horizontal double-walled web and the vertical web.

Furthermore, a single-walled rear region is formed, by the extruded section being subsequently deformed. According to the invention, the transverse beam is therefore constructed as an at least partially separated and/or at least partially unwound extruded section. According to a particularly preferred embodiment, the extruded section is constructed with a rear closed region, which is subsequently separated, after which this region is unwound. Hereby, with relatively few process steps and with little material waste, a great extent can be achieved in the longitudinal direction of the vehicle (i.e. orthogonally to the extrusion direction) to lateral fastening regions for the consoles.

According to the invention, in particular an upper substantially horizontal surface and a lower substantially horizontal surface are formed here, between which a pendulum support mount can be introduced as e.g. a cylindrical sleeve. The section orientation can be selected here so that the upper horizontal surface tapers from a central region laterally outwards, i.e. has a greater longitudinal extent in the central region, in order to receive the pendulum support mount in its upper region, and in the lower surface after unwinding, lateral regions form lugs, projecting obliquely towards the rear, for the connection of the consoles.

According to the invention therefore relatively few, favourably priced process steps are necessary. The production as an extruded section makes a favourably priced construction possible, compared with conventional casting methods etc. for the transverse beams, wherein the double-walled, preferably L-shaped region guarantees a high degree of rigidity. The unwinding by e.g. one or several separation lines—according to the invention a single separation line is possible—can take place in a simple cutting or punching process step, after which the unwinding takes place as shaping of the rear lugs.

According to the invention therefore a production of a stable, rigid transverse beam is possible with little waste, wherein a high degree of freedom is achieved in the shaping.

Preferably, the front axle bracket is produced at least predominantly from a light metal, preferably from aluminium or an aluminium alloy.

The invention is explained below with the aid of the enclosed drawings in an embodiment, in which are shown:

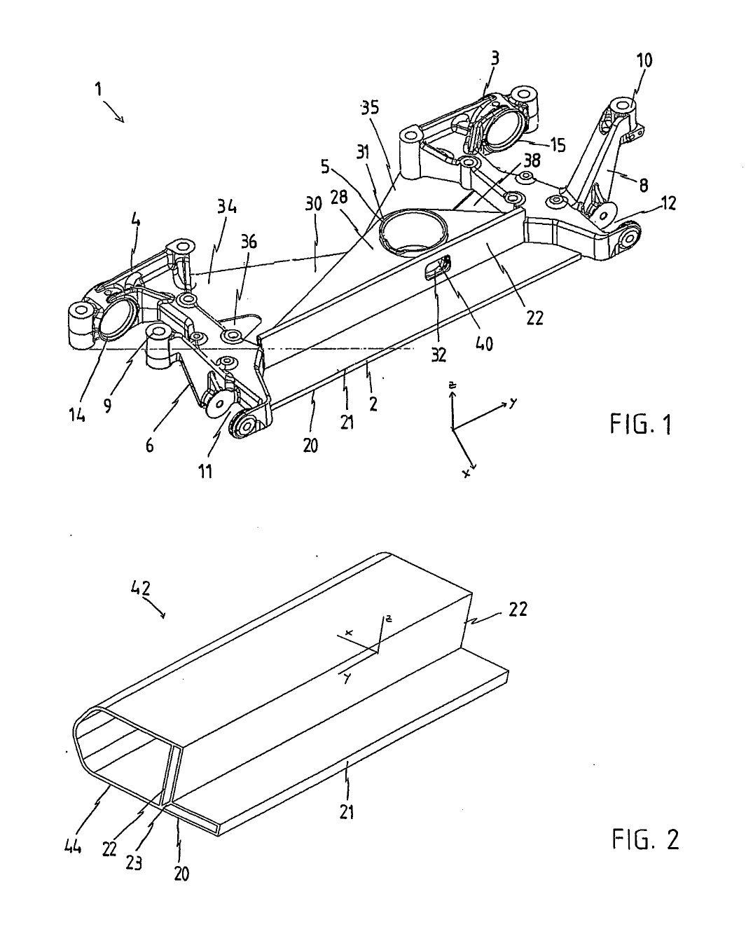

FIG. 1 a front axle bracket according to the invention in perspective view;

FIG. 2 an extruded section according to the invention;

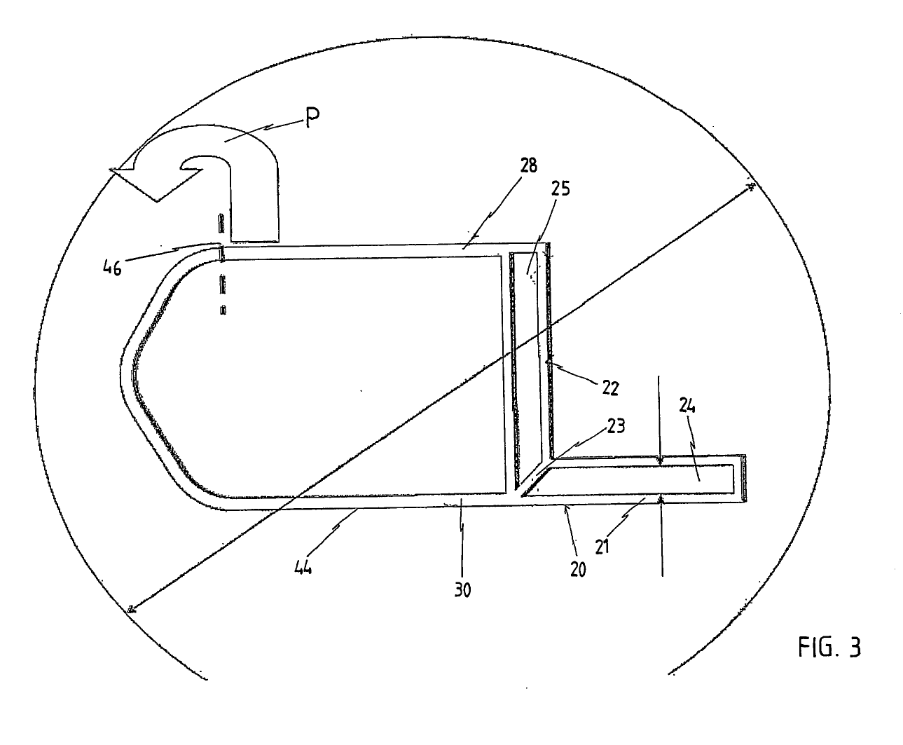

FIG. 3 the extruded section indicating the separation line and unwinding direction in the longitudinal section with respect to the vehicle direction or cross-section with respect to the extruded section;

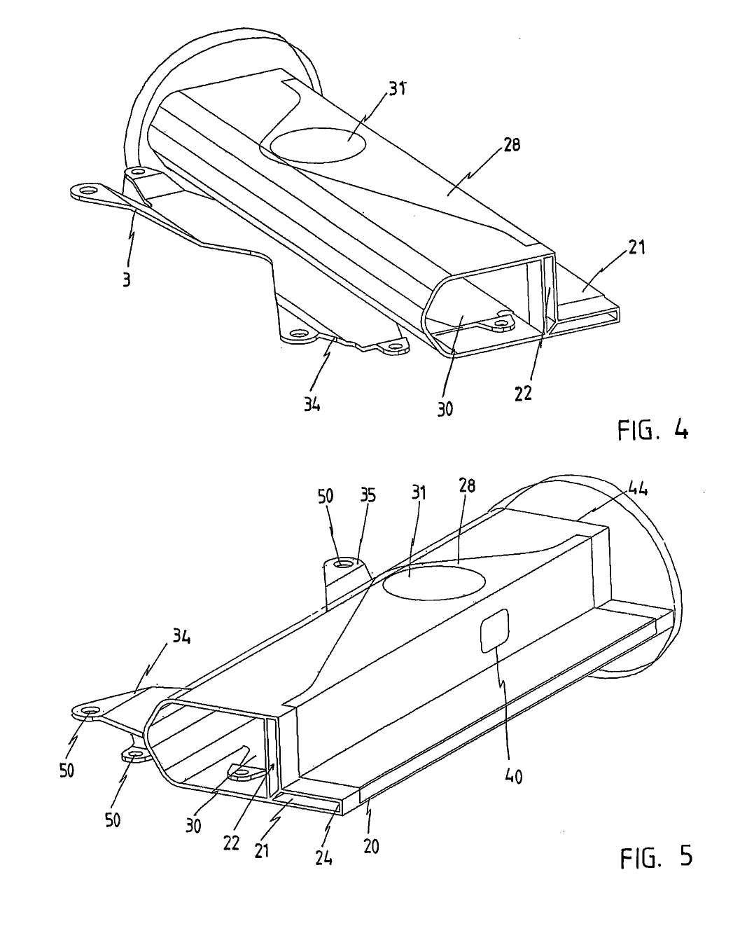

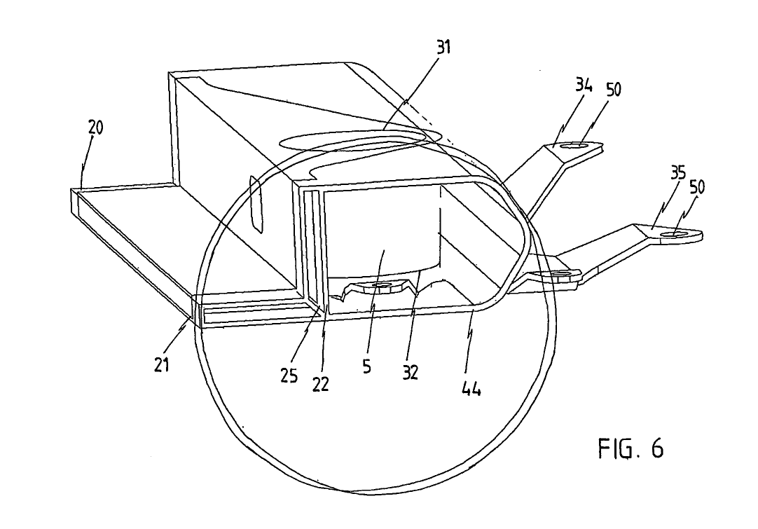

FIG. 4 to 6 various perspective views of the transverse beam, produced by subsequent unwinding of the extruded section, wherein in the figures additionally for illustration furthermore the extruded section is shown.

A front axle bracket 1, shown in FIG. 1, is produced from a light metal, in particular aluminium or an aluminium alloy and has a transverse beam 2 and two lateral consoles 3 and 4. A pendulum support mount 5 is constructed in the transverse beam 2, preferably as a substantially vertically-running cylindrical bearing mount.

On the consoles 3, 4, upwardly-running arms 6, 8 are constructed with mounts 9, 10 for the fastening of the front axle bracket 1 on the vehicle, in addition front bearing mounts 11, 12 for wheel guide suspension links of the vehicle and rear bearing mounts 14, 15 for the wheel bearing mounts. The lateral consoles 3, 4 are constructed as cast parts, if applicable with corresponding finishing for forming the individual mounts.

The transverse beam 2 according to the invention has a front double-walled region 20, which is formed by a double-walled front, horizontally-running web 21 and a double-walled, vertically-running beam 22 adjoining at the rear. A 10 wall 23 runs here between the webs 21 and 22, so that two cavities 24 and 25 are formed with e.g. a minimum thickness of 9 mm.

Adjoining the double-walled region 20 at the rear are a single-walled, upper horizontal surface 28 and, parallel thereto, a lower horizontal surface 30. In the upper horizontal surface 28 a circular recess 31 is formed, in which an upper end of the pendulum support mount 5 is welded in. Accordingly, a lower circular recess 32, which can be seen e.g. in FIG. 6, is formed in the lower horizontal surface 30, in which the lower region of the pendulum support mount 5 is welded in. The upper horizontal surface 28 extends substantially in the central region towards the rear, in order to surround the circular recess 31. The lower horizontal surface 30 extends further towards the rear and comprises two lateral lugs 34, 35, on which rear regions of the consoles 3, 4 are welded. Here, the free spaces 36, 38, which can be seen in FIG. 1, can be formed in the front axle bracket 1 between the transverse beam 2 and the consoles 3, 4, as these regions are not so greatly stressed and a saving of material can therefore be made by these free spaces 36, 38.

Advantageously, the pendulum support is furthermore welded onto the vertical web 22. Through the double-walled vertical web 22 and the pendulum support mount 5, a recess runs forward in longitudinal direction, e.g. for an output shaft.

The entire front axle bracket 1 can be designed symmetrically or substantially symmetrically, wherein the precise geometric shape can be adapted to the lateral position of the pendulum support mount 5, which can be provided somewhat eccentrically in lateral direction.

The transverse beam 2 according to the invention can be produced in a surprisingly simple, favourably priced manner as an unwound extruded section. Here, firstly the extruded section 42 shown in FIG. 2, 3 is produced as an extruded profile from aluminium by cutting to length. The extruded section 42 already has the double-walled region 20 here, to which a closed region 44 adjoins towards the rear. The extrusion direction in the production of the extruded section 42 therefore lies in the transverse direction of the vehicle or Y-direction with respect to the later assembled position. The size and shaping of the closed region 44 is adapted here to the desired shaping of the subsequently produced upper and lower horizontal surface 28, 30.

Proceeding from the extruded section 42, the closed region 44 is separated by a suitable section orientation along the separation line 46, which is shown in FIGS. 3 to 6. It runs on the upper side of the closed region 44 from the laterally outer regions substantially in the transverse direction or extrusion direction towards the centre and then obliquely towards the rear, in order to form the wide region for receiving the recess 31 for the pendulum support mount 5. Laterally on the outside the separating line 46 runs vertically downwards through the double-walled vertical web 22, wherein subsequently in the lower horizontal surface 30 a desired shaping is formed with lateral front lugs 33 projecting slightly outwards. The separation line 46 runs from the front lugs 33 towards the rear and towards the centre, in order to form the free spaces 36, 38, and subsequently towards the rear and towards the exterior for the shaping of the rear lugs 34, 35.

The separation along the separation line 46 can take place by punching or cutting.

The correspondingly separated and cut extruded section 42 is subsequently unwound, for which according to arrow P the rear part of the closed region 44 is unwound or turned over towards the rear. The lugs 34, 35 can be constructed here with a suitable shaping, e.g. with bends 34a, b and 35a, b. Furthermore, holes 50 and the circular recess 31 are formed, wherein these can also be already formed together with the separation line 46, e.g. can be punched.

The pendulum support mount 5 is advantageously placed after unwinding between the upper and lower surface 28, 30 and for example welded by laser welding. Furthermore, the recess 40 is formed, e.g. milled.

The transverse beam 2 according to the invention is therefore able to be produced in few process steps at a favourable cost. It is subsequently connected with the two consoles 3, 4, e.g. by welding and/or by screws set into the holes 50.

### LIST OF REFERENCE NUMBERS

### (Is Part of the Description)

1 front axle bracket
2 transverse beam
3 console
4 console
5 pendulum support mount
6 arm
7 arm
9 mount
10 mount
11 bearing mount
12 bearing mount
14 bearing mount
15 bearing mount
20 double-walled region
21 horizontal web
22 vertical web
23 wall
24 cavity
25 cavity
28 horizontal surface
30 horizontal surface
31 recess
32 recess
33 front lug
34 lug pointing towards the rear
35 lug pointing towards the rear
36 free space
38 free space
40 recess
42 extruded section
44 closed region
46 separation line
50 hole

1. A front axle bracket (1) for a motor vehicle, comprising two lateral consoles (3, 4) and a central transverse beam (2), which connects the two lateral consoles (3, 4), wherein the transverse beam (2) is constructed from an extruded section (42) with a double-walled region (20).

2. The front axle bracket (1), according to claim 1, wherein the transverse beam (2) is constructed as an at least partially separated and/or at least partially unwound extruded section (42).

3. The front axle bracket (1), according to claim 1, wherein the front axle bracket (1) is produced at least predominantly from a light metal.

4. The front axle bracket (1), according to claim 1, wherein the consoles (3, 4) have mounts (9, 10) for fastening on the vehicle and bearing mounts (11, 12, 14, 15) for wheel guide suspension links.

5. The front axle bracket (1), according to claim 1, wherein the double-walled region (20) is constructed in an angular manner with a front horizontal web (21) and an adjoining vertical web (22).

6. The front axle bracket (1) according to claim 5, wherein a wall (23) is formed between the front horizontal double-walled web (21) and the vertical web (22).

7. The front axle bracket (1), according to claim 1, wherein the double-walled region (20) has one or several cavities (24, 25).

8. The front axle bracket (1), according to claim 1, wherein a lower horizontal surface (30) and an upper horizontal surface (28) adjoin the double-walled region (20), between which a pendulum support mount (5) is received, extending substantially in a vertical direction.

9. The front axle bracket (1), according to claim 1, wherein the lower horizontal surface (30) has two lugs (34, 35) pointing obliquely towards the rear for the fastening of the lateral consoles (3, 4).

10. The front axle bracket (1) according to claim 9, wherein free spaces (36, 38) are formed between the transverse beam (2) and the lateral consoles (3, 4).

11. The front axle bracket (1), according to claim 1, wherein the pendulum support mount (5) lies against the double-walled vertical web (22).

12. The front axle bracket (1) according to claim 11, wherein a recess (40) runs substantially in longitudinal direction (X) through the double-walled vertical web (22) and the pendulum support mount (5).

13. A method for the production of a front axle bracket (1), according to claim 1, with at least the following steps: producing lateral consoles (3, 4), producing an extruded section (42) from a light metal or a light metal alloy with a double-walled region (20), separating the extruded section (42) and deforming to a transverse beam (2), and fastening the lateral consoles (3, 4) on the transverse beam (2).

14. The method according to claim 13, wherein an extruded profile (42) is formed with a double-walled region (20) and a closed region (44), and the closed region (44) is subsequently separated in at least one separation line (46) and unwound completely or partially.

15. The method according to claim 14, wherein the separation line (46) is formed in an upper horizontal surface (28) of the closed region (44) and subsequently the rear part of the upper surface (28) is turned towards the rear and downwards, so that the part which is turned towards the rear forms an extension of the lower horizontal surface (30) with mount regions, e.g. lugs (34, 35) for the fastening of the front axle bracket (1).

16. The method according to claim 15, wherein a pendulum support mount (5) is fastened, preferably welded, between the upper horizontal surface (28) and the lower horizontal surface (30) of the separated, unwound closed region (44).

17. The method, according to claim 13, wherein the double-walled region (20) is formed with a double-walled, preferably horizontal web (21) and an adjoining double-walled vertical web (22), preferably in an L-shape.

18. The method, according to claim 15, wherein in the upper horizontal surface (28) a recess (31) is cut for the fastening of an upper region of the pendulum support mount (5).

19. The method, according to claim 13, wherein the separation process takes place by cutting or punching.

20. The method, according to claim 13, wherein the lateral consoles (3, 4) are cast.
